(19) United States
(12) Patent Application Publication
(10) Pub. No.: US 2012/0137089 A1
(43) Pub. Date: May 31, 2012

(54) STORAGE DEVICE, ELECTRONIC DEVICE, AND ACCESS CONTROL METHOD FOR STORAGE DEVICE

(75) Inventors: Kenichi NUMATA, Ome-shi (JP); Teruji YAMAKAWA, Koto-ku (JP)

(73) Assignee: KABUSHIKI KAISHA TOSHIBA, Tokyo (JP)

(21) Appl. No.: 13/282,269

(22) Filed: Oct. 26, 2011

(30) Foreign Application Priority Data
Nov. 26, 2010 (JP) 2010-264317

(51) Int. Cl. G06F 12/00; G06F 12/14

(52) U.S. Cl. 711/156; 711/163; 711/E12.001; 711/E12.098

(57) ABSTRACT

According to one embodiment, a storage device electrically connected to a host includes a storage module, an access restriction module, a first restricted access open module, and a second restricted access open module. The storage module is configured to store therein data. The access restriction module is configured to restrict an access from the host to the storage module after power of the storage device is turned on. The first restricted access open module is configured to open the restricted access from the host to the storage module based on a first command for opening the restricted access from the host. The second restricted access open module is configured to open the restricted access from the host to the storage module based on a second command for carrying out an operation different from the opening of the restricted access from the host.

### CROSS-REFERENCE TO RELATED APPLICATIONS

This application is based upon and claims the benefit of priority from Japanese Patent Application No. 2010-264317, filed Nov. 26, 2010, the entire contents of which are incorporated herein by reference.

### FIELD

Embodiments described herein relate generally to a storage device, an electronic device, and an access control method for a storage device.

### BACKGROUND

Conventionally, storage devices accommodated in a housing of an electronic device are known. In a storage device of this type, an access thereto may be restricted from an electronic device and the like as a host and, when an access authority can be confirmed with a password or the like, the restricted access is opened according to an instruction from the electronic device.

However, in such a conventional setting, depending on the conditions of the electronic device and the storage device, the access restriction may be set involuntarily, thereby causing inconvenience in operation.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an electronic device according to a first embodiment;

FIG. 2 is an exemplary block diagram of a storage device in the first embodiment;

FIG. 3 is an exemplary block diagram of an MPU of the storage device in the first embodiment;

FIG. 4 is an exemplary schematic diagram illustrating ranges and a locking table of the storage device in the first embodiment;

FIG. 5 is an exemplary schematic diagram illustrating MBR shadowing and an MBR control table of the storage device in the first embodiment;

FIG. 6 is an exemplary flowchart of operations of the storage device and the electronic device of when the storage device is reset in the first embodiment;

FIG. 7 is an exemplary flowchart of a part of the operation of the storage device of when the storage device is reset in the first embodiment;

FIG. 8 is an exemplary chart of data indicating statuses held in the storage device in the first embodiment;

FIGS. 9A and 9B are exemplary charts of the MBR control table of the storage device in the first embodiment, FIG. 9A indicating the MBR shadowing in an invalid state and FIG. 9B indicating the MBR shadowing in a valid state;

FIGS. 10A and 10B are exemplary charts of the locking table of the storage device in the first embodiment, FIG. 10A indicating an access restriction in an invalid state and FIG. 10B indicating the access restriction in a valid state;

FIGS. 11A and 11B are exemplary schematic diagrams illustrating command sequences of the storage device and the electronic device in the first embodiment, FIG. 11A indicating in a host reset and FIG. 11B indicating in a stand-by return;

FIG. 12 is an exemplary flowchart of operations of the storage device and the electronic device of when the storage device is reset according to a second embodiment; and

FIG. 13 is an exemplary flowchart of operations of the storage device and the electronic device of when the storage device is reset according to a third embodiment.

### DETAILED DESCRIPTION

In general, according to one embodiment of the invention, a storage device electrically connected to a host, the storage device comprises: a storage module configured to store therein data; an access restriction module configured to restrict an access from the host to the storage module after power of the storage device is turned on; a first restricted access open module configured to open the restricted access from the host to the storage module based on a first command for opening the restricted access from the host; and a second restricted access open module configured to open the restricted access from the host to the storage module based on a second command for carrying out an operation different from the opening of the restricted access from the host.

Following non-limiting embodiments comprise the same constituent elements. Those constituent elements of the same are referred to by the same reference numerals and their redundant explanations are omitted.

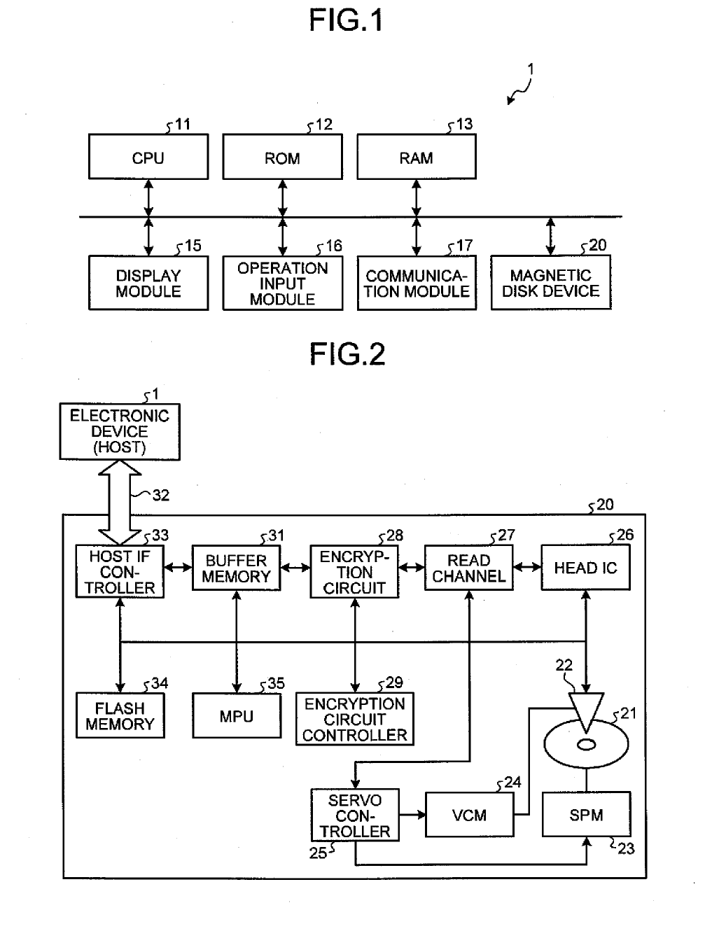

An electronic device 1 such as a personal computer serving to operate as a host comprises, as illustrated in FIG. 1, a central processing unit (CPU) 11, a read only memory (ROM) 12, a random access memory (RAM) 13, a display module 15, an operation input module 16, a communication module 17, a magnetic disk device 20, and such.

The CPU 11 executes various programs installed and stored in advance in the ROM 12, the magnetic disk device 20, and such, and controls operations of various modules constituting the electronic device 1.

The ROM 12 is a non-volatile memory device and stores therein programs concerning the control of the electronic device 1 and various setting information in a non-rewritable manner. The RAM 13 is a volatile memory device and functions as a work area or the like for the CPU 11 and, in various processes, serves as a stack, a buffer, or the like.

The display module 15 is configured as a display device of, for example, a liquid crystal display (LCD), an organic electro-luminescence (EL) display, and the like. The display module 15 displays various types of information based on a signal from the CPU 11.

The operation input module 16 is configured as, for example, a keyboard, a touch panel, or the like. The operation input module 16 sends an instruction signal to the CPU 11 based on the input operation of an operator and such.

The communication module 17 is an interface that communicates with external devices via a communication network not depicted. The communication module 17 sends various types of information received from the external devices to the CPU 11 and sends various types of information output from the CPU 11 to the external devices.

The magnetic disk device 20 stores therein the programs concerning the control of the electronic device 1, various types of data, and such in a rewritable manner. The storage device that the electronic device 1 comprises is not limited to the magnetic disk device (hard disk drive (HDD)) 20, and may be, for example, a solid state drive (SSD), a semiconductor memory (e.g. a flash memory), or the like.

As illustrated in FIG. 2, the magnetic disk device 20 comprises a storage module 21, a head 22, a spindle motor (SPM) 23, a voice coil motor (VCM) 24, a servo controller 25, a head integrated circuit (IC) 26, a read channel 27, an encryption circuit 28, an encryption circuit controller 29, a buffer memory 31, a host IF controller 33, a flash memory 34, a micro processing unit (MPU) 35, and the like.

The storage module 21 is a recording medium in a disk shape that magnetically stores data therein. The head 22 writes data to the storage module 21 and reads out the data written in the storage module 21. The SPM 23 rotationally drives the storage module 21. The VCM 24 comprises a magnet, a drive coil, and the like not depicted and drives the head 22. The servo controller 25 controls the SPM 23 and the VCM 24. The head IC 26 amplifies a signal of data to be written to the storage module 21 by the head 22 and a signal of data read out from the storage module 21. The read channel 27 is a circuit including, for example, a filter, an AGC, an ADC, and a Viterbi decoder. The encryption circuit 28 encrypts the data to be written to the storage module 21 by a given encryption scheme such as an advanced encryption standard (AES) using a given encryption key. Furthermore, the encryption circuit 28 decrypts the data read from the storage module 21 using a given decryption key. The encryption circuit controller 29 controls the operation of the encryption circuit 28.

The buffer memory 31 temporarily stores therein the data to be written to the storage module 21, the data read out from the storage module 21, and the like. The host IF controller 33 controls sending and receiving of data and commands between the electronic device 1 and the magnetic disk device 20 via a host IF 32.

The flash memory 34 is a non-volatile memory that stores therein programs executed by the MPU 35, various types of setting information concerning the operation of the magnetic disk device 20, and the like.

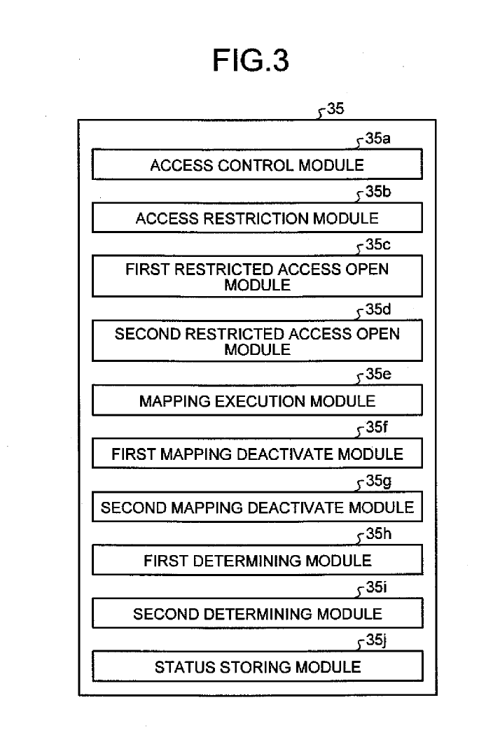

The MPU 35 executes the programs stored in the flash memory 34 to work as later described modules (for example, an access control module 35a, an access restriction module 35b, a first restricted access open module 35c, a second restricted access open module 35d, a mapping module 35e, a first mapping deactivate module 35f, a second mapping deactivate module 35g, a first determining module 35h, a second determining module 35i, a status storing module 35j, and such, see FIG. 3). In other words, the programs include modules that work as the access control module 35a, the access restriction module 35b, the first restricted access open module 35c, the second restricted access open module 35d, the mapping module 35e, the first mapping deactivate module 35f, the second mapping deactivate module 35g, the first determining module 35h, the second determining module 35i, the status storing module 35j, and such. The operations of these modules will be described later.

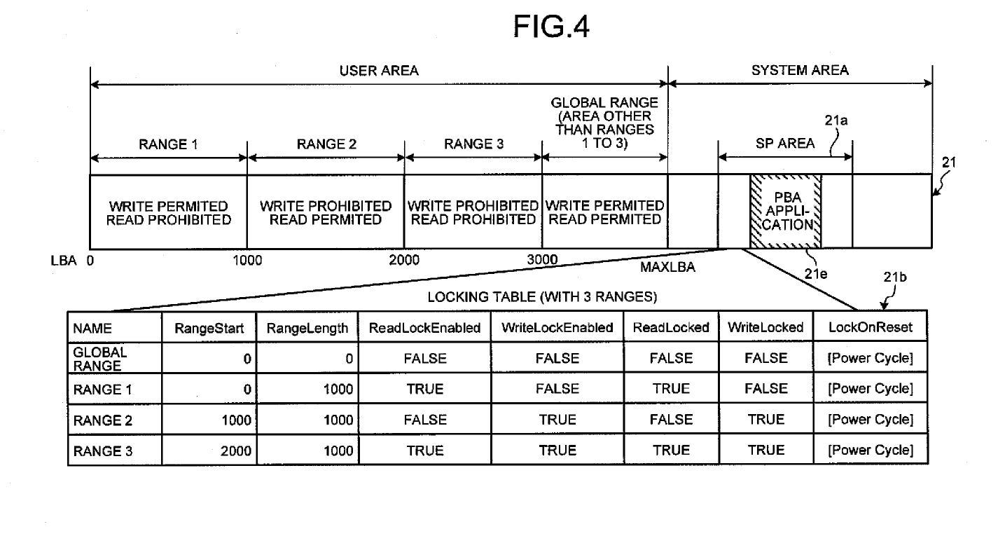

As exemplified in FIG. 4, the storage module 21 has a user area and a system area. The user area can be divided, as illustrated in FIG. 4, into a plurality of areas (ranges). In the example depicted in FIG. 4, the user area is divided into four ranges of a range 1, a range 2, a range 3, and a global range. The global range is an area other than the ranges 1 to 3.

In the present embodiment, the reading/writing can be permitted/prohibited for each of the ranges. This setting is stored in a locking table 21b. The locking table 21b is stored in a security provider (SP) area 21a of the system area. In the locking table 21b, for each of the ranges, values of a start address (RangeStart), a length (RangeLength), a reading prohibition enable/disable flag (ReadLockEnabled), a writing prohibition enable/disable flag (WriteLockEnabled), a reading prohibition status (ReadLocked), a writing prohibition status (WriteLocked), and a restriction on reset flag (LockOnReset) are stored. In the present embodiment, the SP area 21a corresponds to a status storage module.

The start address indicates an address (logical block addressing (LBA)) at which each of the ranges starts. The length indicates a length (number of sectors) of each range.

The reading prohibition enable/disable flag (ReadLockEnabled) is a flag indicating enable/disable of the execution of reading prohibition (whether the reading can be prohibited). If the value is TRUE (for example, one), the reading prohibition can be set for the corresponding range, while if the value is FALSE (for example, zero), the reading prohibition cannot be set for the corresponding range.

The writing prohibition enable/disable flag (WriteLockEnabled) is a flag indicating enable/disable of the execution of writing prohibition (whether the writing can be prohibited). If the value is TRUE (for example, one), the writing prohibition can be set for the corresponding range and, if the value is FALSE (for example, zero), the writing prohibition cannot be set for the corresponding range.

The reading prohibition status (ReadLocked) is a flag indicating the status of whether the reading can be performed (whether the range is in a state capable of being read). If the value is TRUE (for example, one), reading the corresponding range is prohibited and, if the value is FALSE (for example, zero), reading the corresponding range is permitted. However, when the reading prohibition enable/disable flag (ReadLockEnabled) is FALSE, i.e., the reading prohibition cannot be set, the reading is permitted regardless of the value of the reading prohibition status (ReadLocked). In other words, when the value of the reading prohibition enable/disable flag (ReadLockEnabled) is TRUE and the value of the reading prohibition status (ReadLocked) is TRUE, the reading the corresponding range is prohibited. With combinations of other values, the reading is not prohibited.

The writing prohibition status (WriteLocked) is a flag indicating the status of whether the writing can be performed (whether the range is in a state capable of being written). If the value is TRUE (for example, one), writing to the corresponding range is prohibited, while if the value is FALSE (for example, zero), writing to the corresponding range is permitted. However, when the writing prohibition enable/disable flag (WriteLockEnabled) is FALSE, i.e., the writing prohibition cannot be set, the writing is permitted regardless of the value of the writing prohibition status (WriteLocked). In other words, when the value of the writing prohibition enable/disable flag (WriteLockEnabled) is TRUE and the value of the writing prohibition status (WriteLocked) is TRUE, the writing to the corresponding range is prohibited. With combinations of other values, the writing is not prohibited.

The access restriction module 35b, the first restricted access open module 35c, or the second restricted access open module 35d (see FIG. 3) rewrites the reading prohibition status and the writing prohibition status. The access restriction module 35b can rewrite the values of the reading prohibition status and the writing prohibition status from FALSE to TRUE. The first restricted access open module 35c or the second restricted access open module 35d can rewrite the values of the reading prohibition status and the writing prohibition status from TRUE to FALSE. While the first restricted access open module 35c and the second restricted access open module 35d differ in their operating conditions from each other, the operations of rewriting the status value are the same.

The restriction on reset flag (LockOnReset) is a flag indicating whether to set each range to reading/writing prohibition, on resetting (i.e., when shifting from a power-off state to a power-on state) the magnetic disk device 20 as the storage device. The access restriction module 35b rewrites the values of the reading prohibition status and the writing prohibition status from FALSE to TRUE for the ranges of the restriction on reset flag having the value of Power Cycle. When the values of the reading prohibition status and the writing prohibition status are TRUE, they are maintained as TRUE.

The access control module 35a operates according to the values of the read prohibition status and the write prohibition status. More specifically, the access control module 35a does not read data from the ranges with the reading prohibition enable/disable flag having the value of TRUE and with the reading prohibition status having the value of TRUE. On the other hand, the access control module 35a reads data from the ranges other than those with the reading prohibition enable/disable flag having the value of TRUE and with the reading prohibition status having the value of TRUE. Furthermore, the access control module 35a does not write data to the ranges with the writing prohibition enable/disable flag having the value of TRUE and with the writing prohibition status having the value of TRUE. On the other hand, the access control module 35a writes data to the ranges other than those with the writing prohibition enable/disable flag having the value of TRUE and with the writing prohibition status having the value of TRUE.

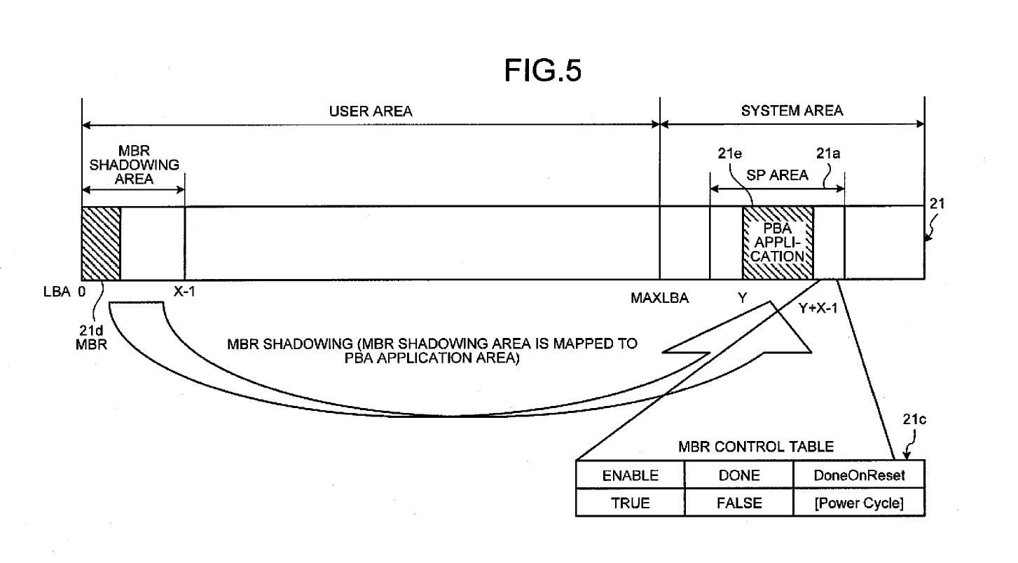

As exemplified in FIG. 5, in the present embodiment, as an example of mapping in which an access to a predetermined area of the storage module 21 is changed to an access to another area, a master boot record (MBR) shadowing is carried out. The MBR shadowing is a mapping of an access to an MBR shadowing area (LBA 0 to X−1 of the storage module 21) 21d from the electronic device 1 as the host to an access to an area in the SP area 21a (pre-boot authentication (PBA) application area 21e, i.e., LBA Y to Y+X−1 of the storage module 21) where a PBA application is stored.

The PBA application is a program operative on the CPU 11 (basic input output system (BIOS)) of the electronic device 1 on resetting the electronic device 1 (i.e., when shifting from a power-off state to a power-off state) to carry out an identity verification based on an account ID and a password. More specifically, the CPU 11 operated according to the PBA application first displays an image (not depicted) that prompts an input of an account ID and a password on the display module 15 of the electronic device 1. The CPU 11 operated according to the PBA application then creates authentication information based on the account ID and the password entered by the operator (user) operating the operation input module 16 and refers to the magnetic disk device 20. When the account ID and the password entered can be confirmed correct, the CPU 11 operated according to the PBA application sends a permit command to the magnetic disk device 20 as the storage device.

In other words, in the present embodiment, by the MBR shadowing, the CPU 11 of the electronic device 1 confirms by the PBA application whether the operator has an authority to log-in or operate, prior to booting the OS. When the authority is confirmed, by cancelling the MBR shadowing, the CPU 11 of the electronic device 1 loads the OS from the storage module 21 and boots it. The magnetic disk device 20 as the storage device deactivates the MBR shadowing and also deactivates the foregoing access restriction when the permit command is received from the electronic device 1 as the host by the operation of the PBA application.

As indicated in FIG. 5, in the SP area 21a of the system area, an MBR control table 21c is stored. The MBR control table 21c stores therein values of an execution enable/disable flag (Enabled) for MBR shadowing, an execution status (Done), and an execution on reset flag (DoneOnReset).

The execution enable flag (Enabled) for MBR shadowing is a flag indicating enable/disable of execution of the MBR shadowing (whether the MBR shadowing can be executed). If the value is TRUE (for example, one), it is possible to execute (set) the MBR shadowing and, if the value is FALSE (for example, zero), it is not possible to execute (set) the MBR shadowing.

The execution status (Done) is a flag indicating the state of whether the MBR shadowing (mapping) is in execution (valid). If the value is TRUE (for example, one), the MBR shadowing is in a finished state, i.e., the state in which the MBR shadowing is deactivated (invalid) and, if the value is FALSE (for example, zero), the MBR shadowing is not in a finished state, i.e., the state in which the MBR shadowing can be executed (valid).

The mapping module 35e, the first mapping deactivate module 35f, or the second mapping deactivate module 35g rewrites the execution status. The mapping module 35e can rewrite the value of the execution status from TRUE to FALSE. The first mapping deactivate module 35f or the second mapping deactivate module 35g can rewrite the value of the execution status from FALSE to TRUE. While the first mapping deactivate module 35f and the second mapping deactivate module 35g differ in their operating conditions from each other, the operations of rewriting the status value are the same.

The execution on reset flag (DoneOnReset) is a flag indicating whether to execute the MBR shadowing when resetting (i.e., when shifting from a power-off state to a power-on state) the magnetic disk device 20 as the storage device. The mapping module 35e rewrites the value of the execution status from TRUE to FALSE if the value of the execution on reset flag is Power Cycle. When the value of the execution status is FALSE, it is maintained as FALSE.

The access control module 35a operates according to the value of the execution status. More specifically, when the value of the execution enable/disable flag is TRUE and the value of the execution status is FALSE, the access control module 35a carries out the foregoing MBR shadowing (mapping). The access control module 35a does not carry out the MBR shadowing (mapping) other than when the value of the execution enable/disable flag is TRUE and the value of the execution status is FALSE.

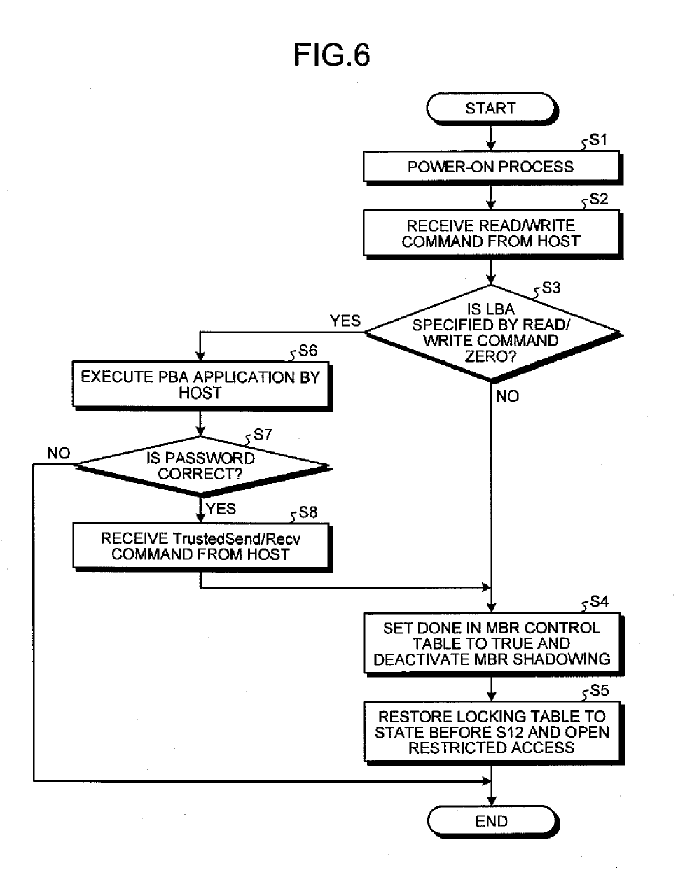

Referring to FIGS. 6 to 10B, the operations of the magnetic disk device 20 and the electronic device 1 at the time of resetting (i.e., when shifting from a power-off state to a power-on state) the magnetic disk device 20 as the storage device according to the present embodiment will be described.

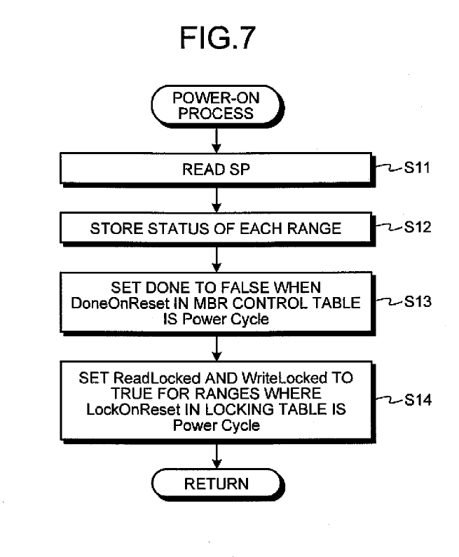

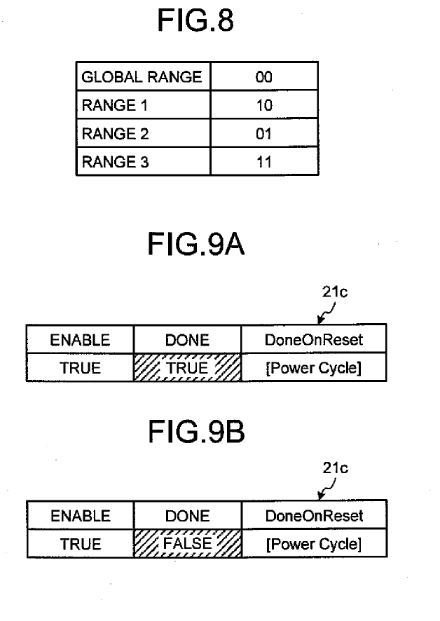

The MPU 35 of the magnetic disk device 20 first executes a power-on process (S1). In the power-on process, as indicated in FIG. 7, the MPU 35 first operates as the status storing module 35j (see FIG. 3) to refer to the locking table 21b in the SP area 21a of the storage module 21 (S11) and then store the data representing the values of the reading prohibition status and the writing prohibition status as the status of each of the ranges in a storage module such as the flash memory 34 (S12). At S12, as exemplified in FIG. 8, the values of the reading prohibition status and the writing prohibition status of each range are stored. In the example indicated in FIG. 8, when the value of the reading prohibition status is TRUE, the left digit of the value in FIG. 8 is one and, when it is FALSE, the left digit of the value in FIG. 8 is zero. When the value of the writing prohibition status is TRUE, the right digit of the value in FIG. 8 is one and, when it is FALSE, the right digit of the value in FIG. 8 is zero. At S12, it is not necessary to store the statuses of all the ranges, but it only needs to store the statuses of at least the ranges with the reading prohibition enable/disable flag or the writing prohibition enable/disable flag having the value of TRUE. In the present embodiment, the flash memory 34 corresponds to a second status storage module. FIG. 8 is merely an example and the values can be stored as other values.

The MPU 35 then operates as the mapping module 35e (see FIG. 3) and, when the execution on reset flag (DoneOnReset) in the MBR control table 21c is Power Cycle, sets the value of the execution status (Done) to FALSE (S13). By the process at S13, when the execution enable/disable flag (Enabled) is TRUE, the MBR shadowing becomes valid (being set). By the process at S13, the MBR control table 21c changes, for example, from the state indicated in FIG. 9A to the state indicated in FIG. 9B. FIG. 9A illustrates the state of the MBR shadowing being deactivated (invalid), and FIG. 9B illustrates the state of the MBR shadowing being set (valid).

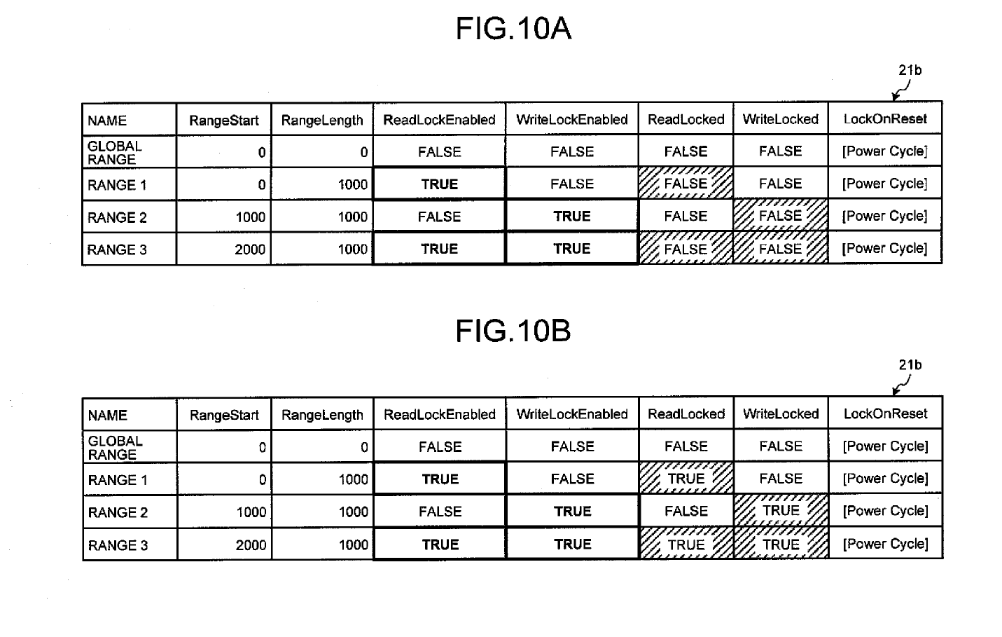

The MPU 35 then operates as the access restriction module 35b (see FIG. 3), and sets the value of the reading prohibition status (ReadLocked) to TRUE for the ranges with the restriction on reset flag (LockOnReset) in the locking table 21b having the value of Power Cycle and with the reading prohibition enable/disable flag (ReadLockEnabled) having the value of TRUE. Furthermore, the MPU 35 operates as the access restriction module 35b, and sets the value of the writing prohibition status (WriteLocked) to TRUE for the ranges with the restriction on reset flag (LockOnReset) having the value of Power Cycle and with the writing prohibition enable/disable flag (WriteLockEnabled) having the value of TRUE (S14). By the process at S14, the reading prohibition is executed (being set) to the ranges to which the reading prohibition can be set, and the writing prohibition is executed (being set) to the ranges to which the writing prohibition can be set. By the process at S14, the locking table 21b changes, for example, from the state indicated in FIG. 10A to the state indicated in FIG. 10B. FIG. 10A illustrates the state in which the restricted access is opened (invalid), and FIG. 10B illustrates the state in which the access restriction is executed (valid).

In other words, in the present embodiment, by the power-on process at S1 (S11 to S14), at the time of resetting the magnetic disk device 20 as the storage device, the PBA application is launched by the MBR shadowing, whereby the operation of an identity verification (authority confirmation) is required and the access restriction to predetermined areas of the storage module 21 is executed. Consequently, the security of data stored in the storage module 21 of the magnetic disk device 20 can be further enhanced.

However, in resetting the magnetic disk device 20 as the storage device, there are a reset at the time the electronic device 1 as the host is turned on (hereinafter, referred to as a host reset) and a reset at the time the magnetic disk device 20 is turned on (being returned) from a stand-by state in which the magnetic disk device 20 as the storage device is turned off while the electronic device 1 is maintained to be turned on (hereinafter, referred to as a stand-by return). The CPU 11 of the electronic device 1 accesses the address of LBA=0 for loading the OS and such at the time of the host reset, while it accesses addresses other than LBA=0 at the time of the stand-by return because loading of the OS and such is not necessary. If the magnetic disk device 20 as the storage device carries out the same operation in both the host reset and the stand-by return, the desired operation cannot be obtained. More specifically, for example, if the MPU 35 of the magnetic disk device 20 executes the MBR shadowing even at the time of the stand-by return similarly to that of the host reset, the required data cannot be returned to the electronic device 1 as the host, whereby problems may occur in operations of the electronic device 1, the magnetic disk device 20, and the like.

In this point, in the present embodiment, changing the operation of the magnetic disk device 20 as the storage device in response to the result of S3 described later makes it easier to avoid the foregoing inconvenient situations to occur.

More specifically, referring back to FIG. 6, when the MPU 35 receives a read command or a write command from the electronic device 1 as the host (S2), the MPU 35 operates as the first determining module 35h (see FIG. 3) to determine whether the address (LBA) of access destination of the read command or the write command received is zero (S3).

At S3, when the command received from the electronic device 1 as the host is the read command or the write command specifying LBA=0, it can be assumed to be in a host reset state. In the present embodiment, when the first determining module 35h determines that the command received from the electronic device 1 as the host is the read command or the write command specifying LBA=0 (Yes at S3), the CPU 11 of the electronic device 1 as the host reads the PBA application by the MBR shadowing (mapping) of the MPU 35 and executes the PBA application (S6). Then, as a result of the verification of a password for an account ID entered with the password stored in the storage module 21 (S7), if the password entered is not a correct password (No at S7), the CPU 11 now operative according to the PBA application may display on the display module 15 an image that prompts reentering an account ID and a password, for example, or may turn the electronic device 1 off.

On the other hand, when the password entered is confirmed to be correct (Yes at S7), the CPU 11 of the electronic device 1 as the host sends permit commands that opens the restricted access (a TrustedSend command and a TrustedRecv command (TrustedSend/Recv commands)) to the magnetic disk device 20 as the storage device. When the MPU 35 now operates as the second determining module 35i (see FIG. 3) determines that the received commands are predetermined permit commands (TrustedSend/Recv commands), i.e., when the predetermined permit commands are received (S8), the MPU 35 operates as the first mapping deactivate module 35f (see FIG. 3) and sets the value of the execution status (Done) in the MBR control table 21c to TRUE. This deactivates the MBR shadowing (S4). By the process at S4, the MBR control table 21c changes the state in FIG. 9B to the state in FIG. 9A.

The MPU 35 that received the permit command at S8 now operates as the first restricted access open module 35c (see FIG. 3) and restores the state of the restricted access to that of before S12 by referring to the values of the reading prohibition status and the writing prohibition status as exemplified in FIG. 8 for each of the ranges stored, for example, in the flash memory 34 as the status storage module. This opens the restricted access (S5). By the process at S5, the locking table 21b changes from the state depicted in FIG. 10B to the state depicted in FIG. 10A. In the present embodiment, the TrustedSend/Recv commands as the permit commands correspond to a first command.

Meanwhile, when the access destination (LBA) of the read command or the write command received from the electronic device 1 as the host at S2 is not zero, it can be assumed to be in a stand-by return state. In the present embodiment, when the first determining module 35h determines that the access destination (LBA) of the read command or the write command received from the electronic device 1 as the host is not zero (No at S3), the MPU 35 operates as the second mapping deactivate module 35g (see FIG. 3) and sets the value of the execution status (Done) in the MBR control table 21c to TRUE. This deactivates the MBR shadowing (S4). By the process at S4, the MBR control table 21c changes the state in FIG. 9B to the state in FIG. 9A.

Furthermore, when determined No at S3, the MPU 35 operates as the second restricted access open module 35d (see FIG. 3) and restores the state of the restricted access to that of before S12 by referring to the values of the reading prohibition status and the writing prohibition status as exemplified in FIG. 8 for each range stored, for example, in the flash memory 34 as the status storage module. This opens the restricted access (S5). By the process at S5, the locking table 21b changes the state in FIG. 10B to the state in FIG. 10A. In the present embodiment, the read command or the write command which is not associated with LBA=0 corresponds to a second command.

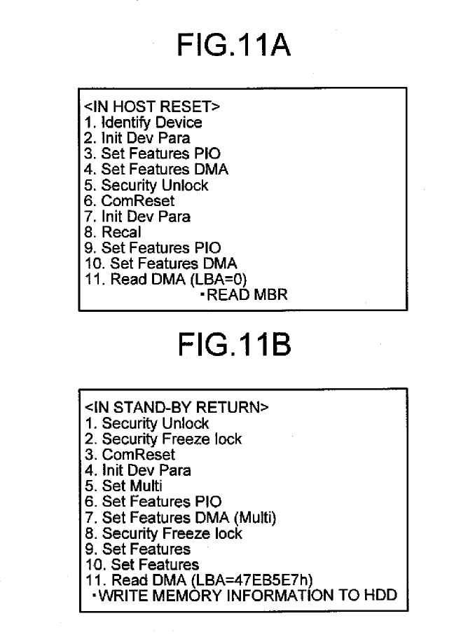

FIG. 11A illustrates an example of a command sequence in the host reset, while FIG. 11B illustrates an example of a command sequence in the stand-by return.

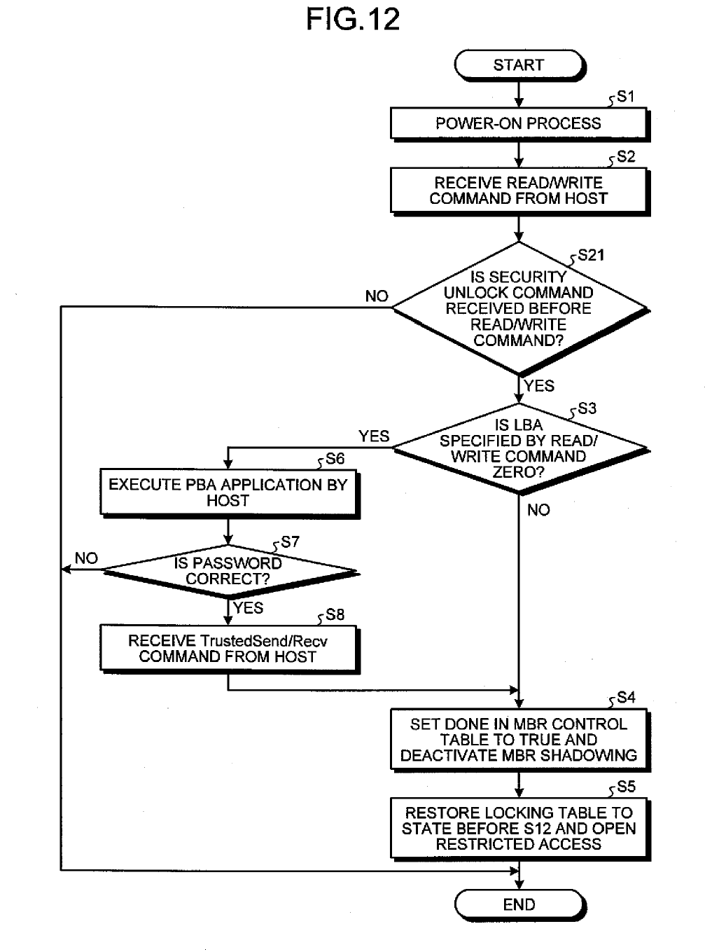

FIG. 12 is a flowchart illustrating the operations of the magnetic disk device 20 and the electronic device 1 when resetting (i.e., shifting from a power-off state to a power-on state) the magnetic disk device 20 as the storage device according to the present embodiment. The difference from that of the first embodiment is that S21 is added after S2 but before S3. Other than S21 to be carried out, the electronic device 1 as the host and the magnetic disk device 20 as the storage device are constructed and operate the same as those of the first embodiment.

In the present embodiment, after S2, the MPU 35 operates as a third determining module and, when a read command or a write command is received at S2, determines whether a security unlock command is received (S21). As illustrated in FIGS. 11A and 11B, the MPU 35 receives, at the time of both the host reset and the stand-by return, the security unlock command prior to the read command or the write command. More specifically, in the present embodiment, by adding S21, the MPU 35 can determine whether it is in the host reset or the stand-by return, or in other states. This makes it possible to avoid involuntary malfunctions of the MPU 35 and such, thereby further enhancing the security. The MPU 35 stores in a given storage module the data (such as a flag) indicative of at least receiving the security unlock command in the command sequence.

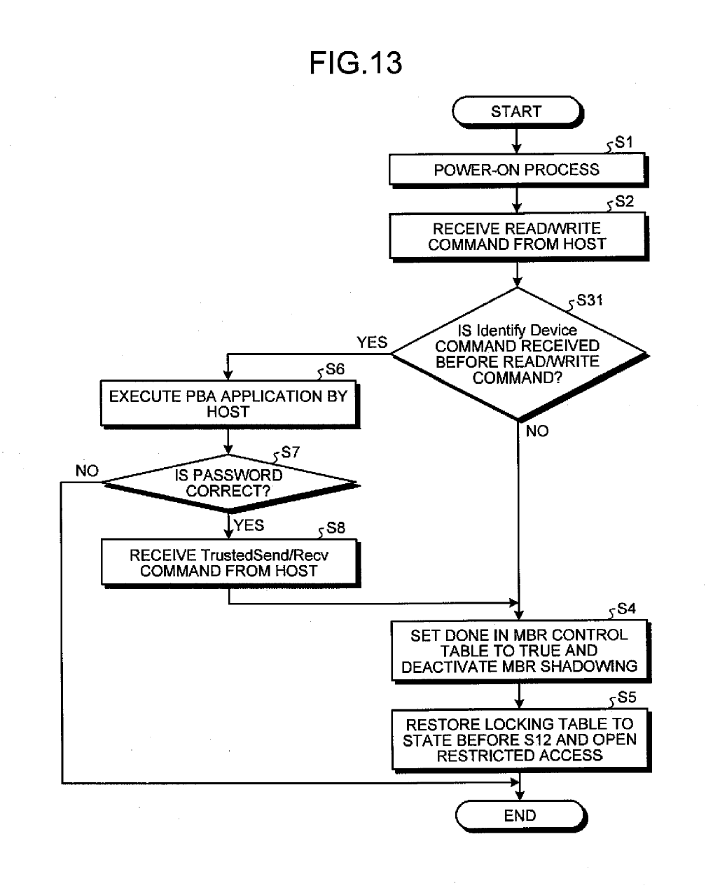

FIG. 13 is a flowchart illustrating the operations of the magnetic disk device 20 and the electronic device 1 when resetting (i.e., shifting from a power-off state to a power-on state) the magnetic disk device 20 as the storage device according to the present embodiment. The difference from that of the first embodiment is that S3 is replaced with S31. Other than S31 to be carried out in place of S3, the electronic device 1 as the host and the magnetic disk device 20 as the storage device are configured and operate the same as those of the first embodiment. In the present embodiment, the command sequences exemplified in FIGS. 11A and 11B are executed.

In the present embodiment, after S2, the MPU 35 is operative as a first determining module different from that of the first embodiment and checks whether an Identify Device command (see FIG. 11A) is received prior to a read command or a write command (S31). The Indentify Device command is a command by which, in the host reset, the electronic device 1 as the host instructs the magnetic disk device 20 as the storage device to send (respond) its identification information (ID and such), attributes, and the like, and is the command which, in the stand-by state, the MPU 35 does not receive (i.e., the electronic device 1 as the host does not send). As indicted in FIG. 11A, in the host reset, the Identify Device command is received before the read command or the write command received at S2, while in the stand-by return, as indicated in FIG. 11B, the Identify Device command is not received. Accordingly, in the present embodiment, when the Identify Device command is received at S31 (Yes at S31), S4 is carried out because receiving it corresponds to the stand-by return and, when the identify device command is not received at S31 (No at S31), S6 is carried out because not receiving it corresponds to the host reset. This obtains the same results as those of the first embodiment. In the present embodiment, the read command or the write command, and the Identify Device command correspond to a second command. In the present embodiment, the read command or the write command received at S2 serves as a trigger to execute S31.

While exemplary embodiments have been explained in the foregoing, the present invention is not limited to those embodiments and various modifications can be made. For example, the constituent elements and processes of the foregoing exemplary embodiments can be appropriately combined. The mapping may be a mapping to other addresses, or a system not carrying out the mapping can be employed. Furthermore, commands other than the foregoing commands that can distinguish each state can be used. Furthermore, a storage device externally connected to an electronic device can be used.

According to the exemplary embodiments, a storage device, an electronic device, and an access control method for a storage device that are less likely to cause inconveniences associated with the access restriction to the storage device can be obtained.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device electrically connected to a host, the storage device comprising:
a storage module configured to store therein data;
an access restriction module configured to restrict an access from the host to the storage module after power of the storage device is turned on;
a first restricted access open module configured to open the restricted access from the host to the storage module based on a first command for opening the restricted access from the host; and
a second restricted access open module configured to open the restricted access from the host to the storage module based on a second command for carrying out an operation different from the opening of the restricted access from the host.

2. The storage device of claim 1, wherein the second restricted access open module is configured to open the restricted access from the host to the storage module when the second restricted access open module receives a predetermined command as the second command, the predetermined command being sent from the host when the power of the storage device is turned on from a stand-by state in which the power of the storage device is turned off while power of the host is turned on.

3. The storage device of claim 1, wherein the second restricted access open module is configured to open the restricted access from the host to the storage module when the second restricted access open module receives a command with an access destination of a predetermined address, as the second command.

4. The storage device of claim 1, further comprising:
a mapping module configured to change an access from the host to a predetermined area of the storage module to an access to another area of the storage module when the power of the host is turned on;
a first mapping deactivate module configured to deactivate a mapping by the mapping module based on the first command; and
a second mapping deactivate module configured to deactivate the mapping by the mapping module based on the second command.

5. The storage device of claim 1, further comprising:
a status storage module configured to store therein data indicating a status of access permission or prohibition with respect to the storage module; and
an access control module configured to control the access to the storage module from the host based on the data indicating the status stored in the status storage module, wherein
the access restriction module, the first restricted access open module, and the second restricted access open module rewrite the data indicating the status of the status storage module.

6. The storage device of claim 5, further comprising:
a status storing module configured to make a second status storage module hold the data indicating the status when the power of the storage device is turned on, wherein
the access restriction module is configured to rewrite the data indicating the status of the status storage module after the status storing module makes the second status storage module hold the data indicating the status when the power of the storage device is turned on.

7. An electronic device comprising a storage device electrically connected to a host, the storage device comprising:
a storage module configured to store therein data;
an access restriction module configured to restrict an access from the host to the storage module after power of the storage device is turned on;
a first restricted access open module configured to open the restricted access from the host to the storage module based on a first command for opening the restricted access from the host; and
a second restricted access open module configured to open the restricted access from the host to the storage module based on a second command for carrying out an operation different from the opening of the restricted access from the host, wherein
the electronic device is configured to accommodate the storage device in a housing thereof and to function as the host.

8. The electronic device of claim 7, wherein the second restricted access open module is configured to open the restricted access from the host to the storage module when the second restricted access open module receives a predetermined command as the second command, the predetermined command being sent from the host when the power of the storage device is turned on from a stand-by state in which the power of the storage device is turned off while power of the host is turned on.

9. The electronic device of claim 7, wherein the second restricted access open module is configured to open the restricted access from the host to the storage module when the second restricted access open module receives a command with an access destination of a predetermined address, as the second command.

10. The electronic device of claim 7, further comprising:
a mapping module configured to change an access from the host to a predetermined area of the storage module to an access to another area of the storage module when the power of the host is turned on;
a first mapping deactivate module configured to deactivate a mapping by the mapping module based on the first command; and
a second mapping deactivate module configured to deactivate the mapping by the mapping module based on the second command.

11. The electronic device of claim 7, further comprising:
a status storage module configured to store therein data indicating a status of access permission or prohibition with respect to the storage module; and
an access control module configured to control the access to the storage module from the host based on the data indicating the status stored in the status storage module, wherein
the access restriction module, the first restricted access open module, and the second restricted access open module rewrite the data indicating the status of the status storage module.

12. The electronic device of claim 11, further comprising:
a status storing module configured to make a second status storage module hold the data indicating the status when the power of the storage device is turned on, wherein
the access restriction module is configured to rewrite the data indicating the status of the status storage module after the status storing module makes the second status storage module hold the data indicating the status when the power of the storage device is turned on.

13. An access control method for a storage device electrically connected to a host and comprising a storage module, the access control method comprising:
restricting, by the storage device, an access from the host to the storage module after power of the storage device is turned on; and
opening, by the storage device, the restricted access from the host based on a predetermined command for carry out an operation different from the opening of the restricted access from the host.

14. The access control method of claim 13, wherein the opening comprises opening the restricted access from the host to the storage module upon receipt of the predetermined command, the predetermined command being sent from the host when the power of the storage device is turned on from a stand-by state in which the power of the storage device is turned off while power of the host is turned on.

15. The access control method of claim 13, wherein the opening comprises opening the restricted access from the host to the storage module upon receipt of a command with an access destination of a predetermined address, as the predetermined command.

16. The access control method of claim 13, further comprising:
changing an access from the host to a predetermined area of the storage module to an access to another area of the storage module when the power of the host is turned on;
deactivating the changing based on a first command for opening the restricted access from the host; and
deactivating the changing based on the predetermined command.

17. The access control method of claim 13, further comprising:
storing, in a status storage module, data indicating a status of access permission or prohibition with respect to the storage module; and
controlling the access to the storage module from the host based on the data indicating the status stored in the status storage module, wherein
the restricting and the opening comprise rewriting the data indicating the status of the status storage module.

18. The access control method of claim 17, further comprising:
making a second status storage module hold the data indicating the status when the power of the storage device is turned on, wherein
the restricting comprises rewriting the data indicating the status of the status storage module after making the second status storage module hold the data indicating the status when the power of the storage device is turned on.
